(19) United States
(12) Patent Application Publication
(10) Pub. No.: US 2009/0101213 A1
(43) Pub. Date: Apr. 23, 2009

(54) APPARATUS FOR CONTROLLING AND METERING FLUID FLOW

(75) Inventor: John Allan Kielb, Eden Prairie, MN (US)

Correspondence Address: MERCHANT & GOULD PC, P.O. BOX 2903, MINNEAPOLIS, MN, 55402-0903, US

(73) Assignee: Rivatek, Inc., St. Louis Park, MN (US)

(21) Appl. No.: 11/875,420

(22) Filed: Oct. 19, 2007

(51) Int. Cl. G05D 7/00; F15B 13/02

(52) U.S. Cl. 137/12; 137/495; 137/557; 700/282

(57) ABSTRACT

An orifice assembly includes a sleeve and a rod. The sleeve has a first axial end, a second axial end, an outer surface, and a bore that extends through the first and second axial ends. The second axial end defines a first opening and a second opening that extend from the outer surface into the bore. The rod includes a first portion and a second portion that is adapted for linear sliding movement in the bore of the sleeve. The second portion includes an end that cooperates with the first and second openings in the sleeve to define a first variable orifice and a second variable orifice.

### TECHNICAL FIELD

The present disclosure relates to fluid flow, and more particularly to a variable orifice for metering and controlling fluid flow.

### BACKGROUND

In process control industries, it is common to use small diameter tubes to carry process fluids at low flow rates when small amounts of fluids are required for manufacturing processes. The tubes are almost always of a circular cross-section. Instruments used to measure a flow rate in the tubes must interface with a fluid flowing in the tube while minimizing disturbance to the fluid flow. To minimize disturbance to the fluid flow, the instrument typically includes a circular cross-section to match the cross-section of the tubes. The flow rate for a flow meter measuring a change in pressure across an orifice is defined by the following equation:

$$Q = \frac{K * π * {d}^{1 / 2}}{4} * {( 2 * \frac{{P}_{HI} - {P}_{LO}}{ρ} )}^{1 / 2} ,$$

where Q is the volumetric flow rate, K is the orifice flow coefficient, d is the hydraulic diameter of the orifice, P_{HI} is the upstream pressure, P_{LO} is the downstream pressure, and ρ is the density of the fluid.

Flow meters used for measuring flow rates in small tubes can have the pressure sensors and orifice integrated in the same housing. Since the flow rate is a function of the cross-sectional area of the orifice, it is important to know with precision the size of the orifice opening. Typically, orifice based flow meters include an orifice having a fixed opening and the user is required to change the entire flow meter in order to obtain a different orifice size to accommodate different flow rates. Attempts have been made to produce flow meters with variable orifices. However, if the orifice opening does not retain a consistent shape as the size of the orifice opening is changed, errors result when calculating the flow rate using the above flow equation. For example, if a circular orifice compresses into a slightly elliptical shape rather than a perfect circular shape, an error can result when calculating the flow rate because the area value for the equation assumes the shape will remain circular. Also, the shape of the front edge and the rear edge of the orifice directly affect the discharge coefficient of the orifice and subsequent flow characteristics of the orifice. If the shape of the front edge or rear edge of the orifice changes with the size of the opening, flow characteristics of the orifice will change continuously. If the discharge coefficient is not consistent as the size of the orifice opening changes, and if it is not known with precision, errors will again result using the above flow equation.

Metering and controlling fluid flow is most commonly performed using separate devices or at least separate features included in a single device. For example, a device that meters fluid flow using an orifice can include a separate valve member that controls the amount of fluid flowing through the flow tubes, and therefore the orifice. In other applications, a separate valve device is positioned in the flow path before or after the metering device. In either scenario, the separate nature of the metering and controlling functions results in a bulky and often expensive arrangement for performing both metering and control of the fluid flow. Also, because the separate features must be connected together, additional seals or gaskets are required to prevent leaks.

Known variable orifice devices are ineffective for several reasons. First, known variable orifice devices typically use circular or curved members that are moved with respect to the fluid flow to change the size of the orifice. Because of the curved nature of these members, the shape of the orifice changes as the size of the orifice changes, which results in significant errors when calculating the fluid flow over a range of orifice sizes. Second, the changed shape of the orifice leads to non-ideal orifice shapes for at least a portion of the flow range. This leads to inconsistent flow characteristics for any given opening as flow rate changes, again leading to errors in the calculation of fluid flow.

A flow device that addresses these and other shortcomings of known flow control and metering devices would be an important advance in the art.

### SUMMARY

An aspect of the present disclosure relates to an orifice assembly including a sleeve and a rod. The sleeve has a first axial end, a second axial end, an outer surface, and a bore that extends through the first and second axial ends. The second axial end defines a first opening and a second opening that extend from the outer surface into the bore. The rod includes a first portion and a second portion that is adapted for linear sliding movement in the bore of the sleeve. The second portion includes an end that cooperates with the first and second openings in the sleeve to define a first variable orifice and a second variable orifice.

Another aspect of the present disclosure relates to a flow device for controlling fluid flow. The flow device includes a housing, a pressure sensor, and an orifice assembly. The housing defines a conduit having an inlet portion, an outlet portion, and an orifice portion disposed between the inlet and outlet portions. The pressure sensor is disposed in the housing for measuring the pressure of fluid in the conduit. The orifice assembly is disposed in the orifice portion of the conduit and includes a rod that is slidably moveable within a bore of a sleeve that defines a first opening and a second opening. The rod cooperates with the first opening and the second opening to define a first variable orifice and a second variable orifice in series.

Another aspect of the present disclosure relates to a method for controlling a flow device assembly. The method includes the steps of measuring the pressure of fluid in a conduit of a housing of the flow device assembly with a pressure sensor disposed in the housing. The position of a rod in a sleeve of an orifice assembly, which is disposed in an orifice portion of the conduit, is measured. An end of the rod and a first opening and a second opening cooperate to define a first variable orifice and a second variable orifice. The flow rate of the fluid through the first variable orifice and the second variable orifice is computed. The size of the first variable orifice and the second variable orifice is adjusted by moving the rod relative to the sleeve.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DESCRIPTION OF THE DRAWINGS

FIG. 1 is a perspective view of a flow device having features that are examples of aspects in accordance with the principles of the present disclosure.

FIG. 2 is a top view of the flow device of FIG. 1.

FIG. 3 is a cross sectional view of the flow device of FIG. 1 taken on line 3-3 of FIG. 2.

FIG. 4 is an enlarged, fragmentary, cross-sectional view of the flow device of FIG. 3.

FIG. 5 is a schematic representation of an orifice assembly having features that are examples of aspects in accordance with the principles of the present disclosure.

FIG. 6 is a perspective view of the orifice assembly of FIG. 5.

FIG. 7 is an enlarged, fragmentary cross-sectional view of the flow device of FIG. 1 taken on line 7-7 of FIG. 4.

FIG. 8 is a perspective view of the orifice assembly of FIG. 5.

FIG. 9 is a perspective view of the orifice assembly of FIG. 5.

FIG. 10 is a cross-sectional view of a flow device assembly having the flow device of FIG. 1 and an electronic controller.

FIG. 11 is an enlarged, fragmentary cross-sectional view of the flow device of FIG. 1 taken on line 11-11 of FIG. 3.

FIG. 12 is a functional block diagram of the various elements of the flow device assembly of FIG. 10.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

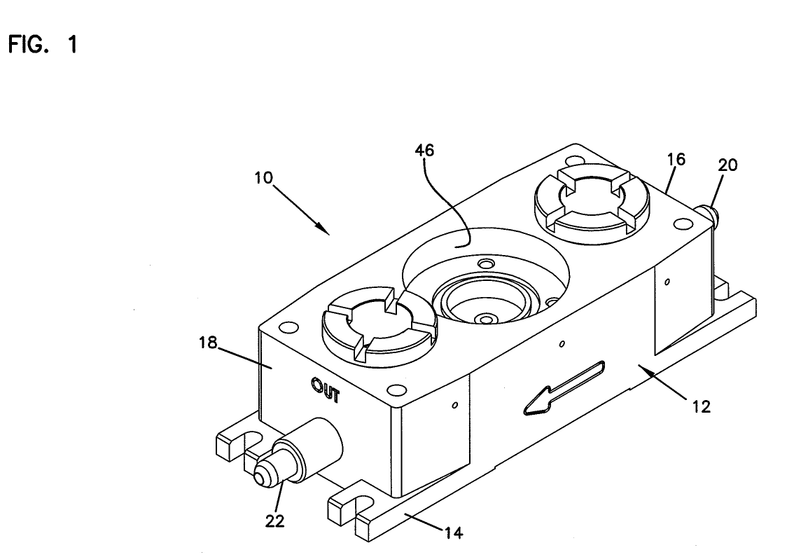

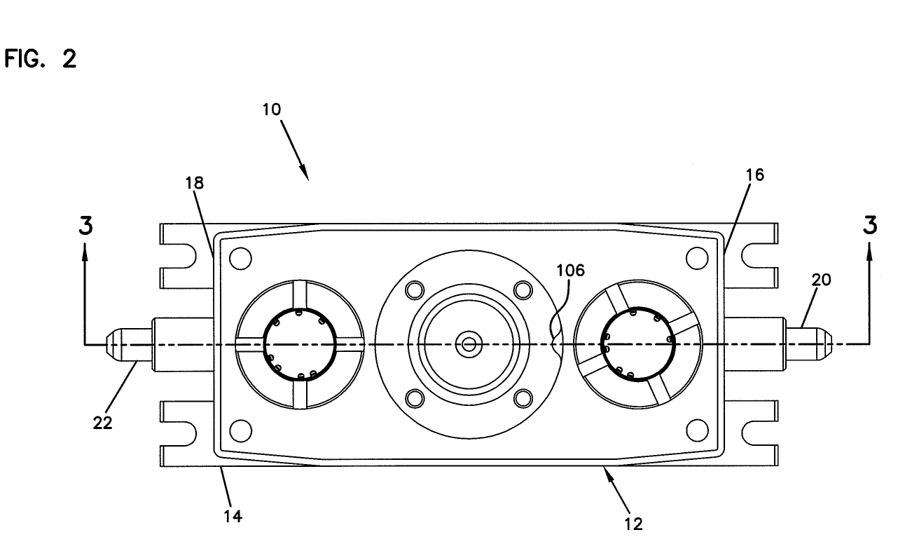

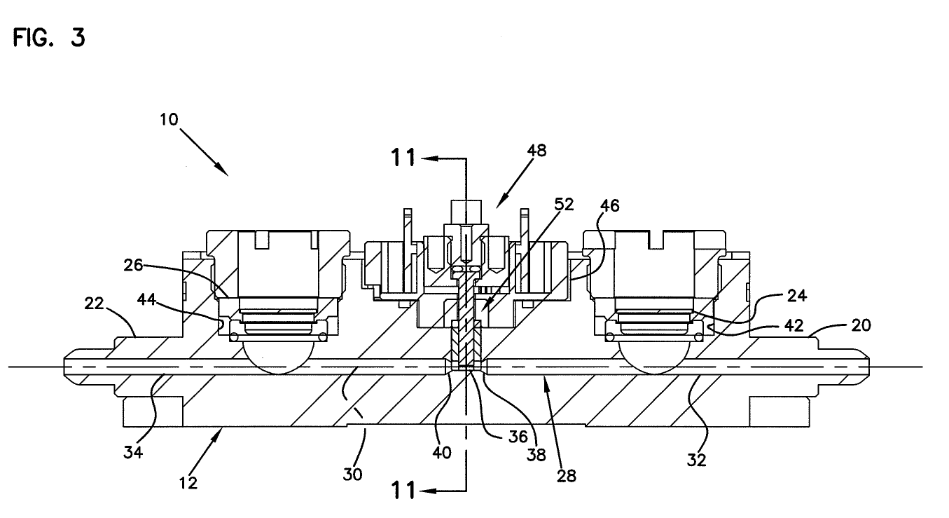

Referring now to FIGS. 1 and 2, a flow device, generally designated 10, for controlling and metering fluid flow is shown. The flow device 10 includes a housing, generally designated 12, having a base 14, a first end portion 16 and an oppositely disposed second end portion 18. In the subject embodiment, an inlet connector 20 (best shown in FIG. 2) is disposed at the first end portion 16 of the housing 12 while an outlet connector 22 is disposed at the second end portion 18. The flow device 10 further includes an inlet pressure sensor 24 (shown in FIG. 3), which is in connected engagement with the housing 12 near the first end portion 16, and an outlet pressure sensor 26 (shown in FIG. 3), which is in connected engagement with the housing 12 near the second end portion 18.

Referring now to FIG. 3, the housing 12 defines a conduit, generally designated 28, that provides fluid communication between the inlet connector 20 and the outlet connector 22. In the subject embodiment, the conduit 28 is aligned along a longitudinal axis 30 (shown as a dashed line in FIG. 3) through the housing 12. It will be understood, however, that the scope of the present disclosure is not limited to the conduit 28 being aligned along the longitudinal axis 30. The conduit 28 includes an inlet portion 32, an outlet portion 34 and an orifice portion 36, which is disposed between the inlet and outlet portions 32, 34. The inlet and outlet portions 32, 34 are generally cylindrical in shape and have diameters that are approximately equal. It will be understood, however, that the scope of the present disclosure is not limited to the inlet and outlet portions 32, 34 being cylindrical in shape or having diameters that are approximately equal. In the subject embodiment, the orifice portion 36 is a cylindrical bore that extends in a generally perpendicular direction relative to the longitudinal axis 30. The inner diameter of the orifice portion 36 is such that the orifice portion 36 intersects the inlet and outlet portions 32, 34, thereby allowing fluid to flow from the inlet to outlet portions 32, 34 through the orifice portion 36.

In the subject embodiment, the inlet and outlet portions 32, 34 include chamfers 38, 40 at the interface between the orifice portion 36 and the inlet and outlet portions 32, 34, respectively. The chamfers 38, 40 in the conduit 28 provide for smooth flow transitions into and out of the orifice portion 36. The chamfers 38, 40 further minimize the potential “dead volume” in the conduit 28 where any solid material carried by the fluid could settle out of the fluid forming a deposit in the conduit 28. It will be understood, however, that the scope of the present disclosure is not limited to the inlet and outlet portions 32, 34 having chamfers 38, 40 at the orifice portion 36.

The housing 12 further defines an inlet sensor bore 42, in which is disposed the inlet pressure sensor 24, an outlet sensor bore 44, in which is disposed the outlet pressure sensor 26, and an actuator cavity 46. The inlet and outlet sensor bores 42, 44 are in fluid communication with the inlet and outlet portions 32, 34 of the conduit 28, respectively. In the subject embodiment, the actuator cavity 46 is disposed in the housing 12 between the inlet and outlet sensor bores 42, 44 and is in communication with the orifice portion 36 of the conduit 28.

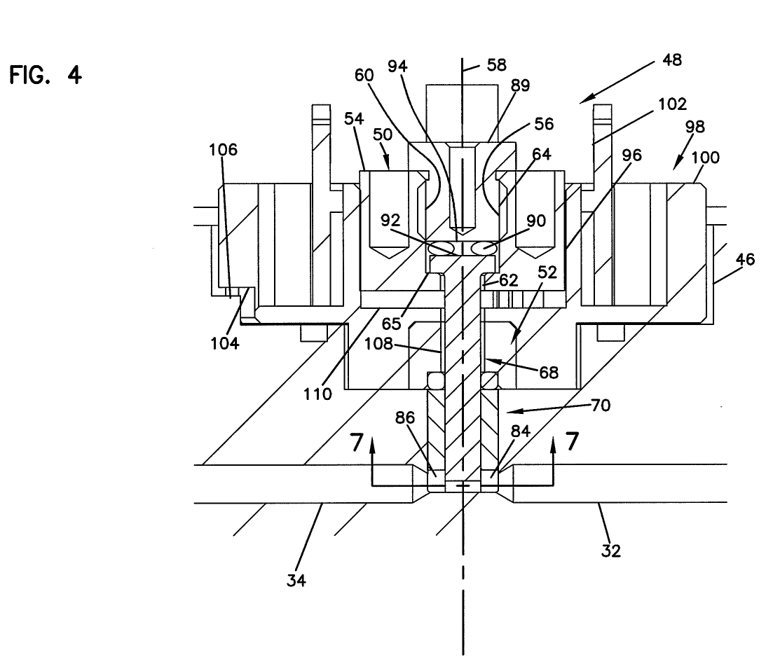

Referring now to FIG. 4, an exemplary embodiment of an actuator assembly, generally designated 48, will be described. The actuator assembly 48 is disposed in the actuator cavity 46. The actuator assembly 48 selectively controls the amount of fluid communicated between the inlet connector 20 and the outlet connector 22 of the flow device 10. In the subject embodiment, the actuator assembly 48 includes an actuator collar, generally designated 50, and an orifice assembly, generally designated 52.

The actuator collar 50 includes a main body 54, which is generally cylindrical in shape. The main body 54 of the actuator collar 50 defines a central opening 56 aligned with a central axis 58 of the actuator collar 50. In the subject embodiment, the central opening 56 includes a first end 60 and an oppositely disposed second end 62. In the subject embodiment, the first end 60 of the central opening 56 includes an internally threaded portion 64. It will be understood, however, that the scope of the present disclosure is not limited to the central opening 56 having an internally threaded portion 64.

The second end 62 of the central opening 56 has a diameter that is smaller than the diameter of the first end 60. The difference in diameters of the first and second ends 60, 62 forms a step 65 disposed between the first and second ends 60, 62.

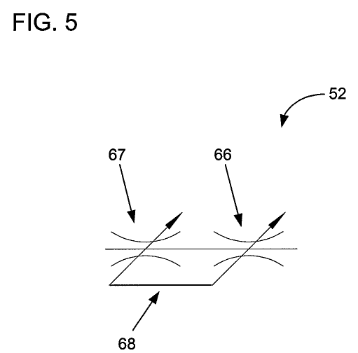

Referring now to FIG. 5, a schematic representation of the orifice assembly 52 is shown. The orifice assembly 52 includes a first variable orifice 66 and a second variable orifice 67 that is in series with the first variable orifice 66. In the subject embodiment, the variability of the first and second variable orifices 66, 67 is controlled by a rod, generally designated 68, which will be described in greater detail subsequently.

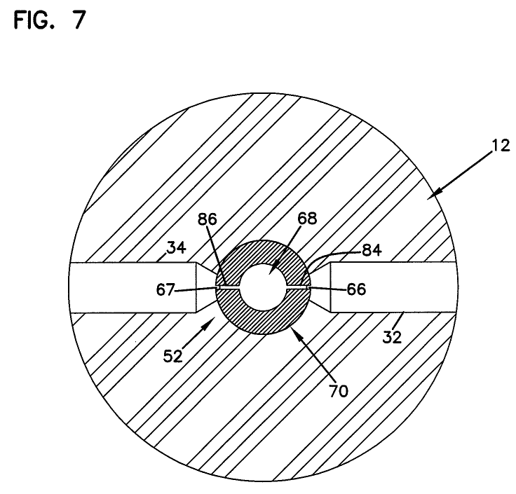

Referring now to FIGS. 4, 6 and 7, an exemplary embodiment of the orifice assembly 52 will be described. The orifice assembly 52 includes the rod 68 and a sleeve, generally designated 70. The rod 68 and sleeve 70 can comprise materials that have such properties and characteristics as corrosion resistance, resistance to wear, ability to machine to tight tolerances, acceptable to users in the industry, stability over time, low coefficient of thermal expansion, and cost effectiveness.

In one embodiment, the rod 68 and the sleeve are each manufactured from single crystal sapphire so as to be compatible with chemicals flowing through the fluid device 10. It will be understood, however, that the scope of the present disclosure is not limited to the rod 68 and the sleeve 70 being manufactured from single crystal sapphire, as the rod 68 and the sleeve 70 could be manufactured from various materials including, but not limited to ceramic, PEEK, and stainless steel.

The rod 68 includes a first portion 72 and a second portion 74 that is adapted for selective sliding linear movement with the sleeve 70. In the subject embodiment, the first and second portions 72, 74 are generally cylindrical in shape and coaxial. The first portion 72 has an outer diameter D₁ while the second portion 74 has an outer diameter D₂. In the subject embodiment, the outer diameter D₂ of the second portion 74 is generally consistent along the length of the second portion 74. In the subject embodiment, and by way of example only, the outer diameter D₂ of the second portion 74 is in the range of about 1/20 inches (0.05 inches) to about ½ inches (0.50 inches). In another embodiment, and by way of example only, the outer diameter D₂ of the second portion 74 is in the range of about ⅛ inches (0.125 inches) to about 3/16 inches (0.175 inches), and preferably about 3/20 inches (0.150 inches).

It will be understood, however, that the scope of the present disclosure is not limited to the second portion 74 of the rod 68 being generally cylindrical in shape, being coaxial with the first portion 72, or having a consistent outer diameter D₂ along the length of the second portion 74. In the subject embodiment, the outer diameter D₁ of the first portion 72 is larger than the outer diameter D₂ of the second portion 74. The difference in the outer diameters D₁, D₂ of the first and second portions 72, 74 of the rod 68 form a shoulder 75 disposed between the first and second portions 72, 74.

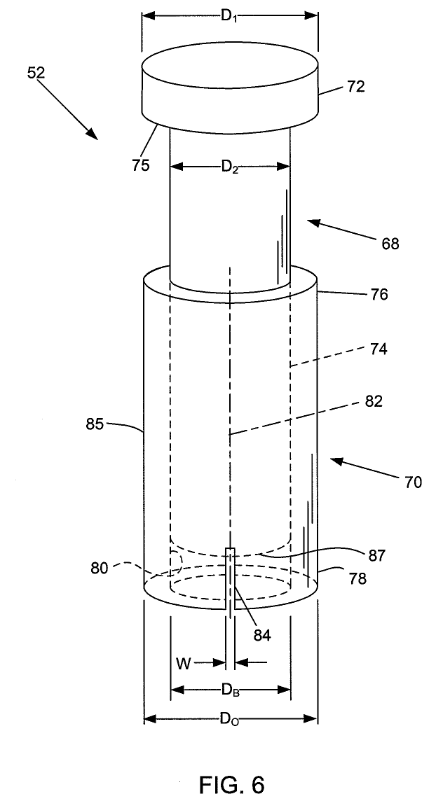

In the subject embodiment, the sleeve 70 of the orifice assembly 52 is generally cylindrical in shape and includes a first axial end portion 76 and a second axial end portion 78. The sleeve 70 defines a bore 80 that extends through the first and second axial end portions 76, 78 and is disposed along a center axis 82 (shown as a dashed line in FIG. 6) of the sleeve 70. The bore 80 of the sleeve 70 and the rod 68 are adapted for linear sliding engagement. As such, the bore 80 has an inner diameter D_{B} that is slightly oversized relative to the outer diameter D₂ of the second portion 74 of the rod 68. In addition to being sized to allow for the linear sliding engagement between the sleeve 70 and the rod 68, the inner diameter D_{B} of the bore 80 is sized to minimize leakage of fluid between the sleeve 70 and the rod 68. In one embodiment, the inner diameter D_{B} of the bore 80 is oversized relative to the outer diameter D₂ by about less than 0.0005 inches. In another embodiment, the inner diameter D_{B} of the bore 80 is oversized relative to the outer diameter D₂ by about less than 0.0002 inches. In another embodiment, the inner diameter D_{B} of the bore 80 is oversized relative to the outer diameter D₂ by about less than 0.00015 inches.

The sleeve 70 of the orifice assembly 52 is engaged with the orifice portion 36 of the conduit 28 so that the center axis 82 of the sleeve 70 is generally perpendicular to the longitudinal axis 30 of the conduit 28. In the subject embodiment, an outer diameter D_{O} of the sleeve 70 is sized for a press fit engagement with an inner diameter of the orifice portion 36. It will be understood, however, that the scope of the present disclosure is not limited to the sleeve 70 being in press fit engagement with the orifice portion 36 of the housing 12 as the sleeve 70 could alternatively be in some other form of engagement with the orifice portion 36, such as threaded, bonded, soldered, etc.

Referring now to FIGS. 4-7, the first and second variable orifices 66, 67 in the orifice assembly 52 will be described. The first and second variable orifices 66, 67 in the orifice assembly 52 are fluid paths through which fluid in the inlet portion 32 of the conduit 28 flows to the outlet portion 34 of the conduit 28. The first and second variable orifices 66, 67 are defined by the interaction between first and second openings 84, 86, which are disposed in the second axial end portion 78 of the sleeve 70, and an end 87 of the second portion 74 of the rod 68.

The first and second openings 84, 86 in the second axial end portion 78 of the sleeve 70 extend from an outer surface 85 of the sleeve 70 into the bore 80. In the subject embodiment, the first and second openings 84, 86 are similar in shape and dimension. It will be understood, however, that the scope of the present disclosure is not limited to the first and second openings 84, 86 being similar in shape and dimension as the second opening 86 could be configured differently than the first opening 84. In one embodiment, and by way of example only, each of the first and second openings 84, 86 is generally rectangular in shape and has a width W (shown in FIG. 6). The width W can be, for example, in the range of about 0.005 to about 0.1 inches, more preferably in the range of about 0.005 to about 0.05 inches, and more preferably in the range of about 0.01 to about 0.02 inches. The width W can be characterized in other arrangements as being smaller than about 0.01 inches, more preferably smaller than about 0.02 inches, and more preferably smaller than about 0.01 inches.

In the subject embodiment, the first and second openings 84, 86 are oriented about the second axial end portion 78 of the sleeve 70 so as to be approximately 180 degrees apart. It will be understood, however, that the scope of the present disclosure is not limited to the first and second openings 84, 86 being 180 degrees apart. For example, in some arrangements the openings 84, 86 can be oriented in the range of about 90 degrees to about 270 degrees apart, and more preferably in the range of about 160 degrees to about 200 degrees apart. The sleeve 70 is oriented within the orifice portion 36 of the conduit 28 such that the first opening 84 is in communication with the inlet portion 32 of the conduit 28 while the second opening 86 is oriented within the orifice portion 36 so as to be in communication with the outlet portion 34.

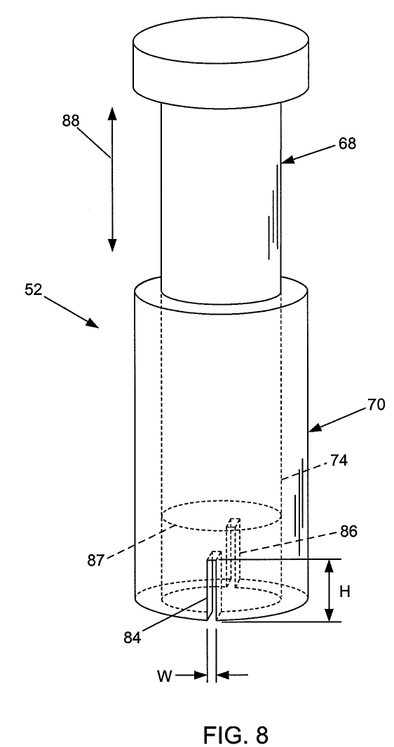

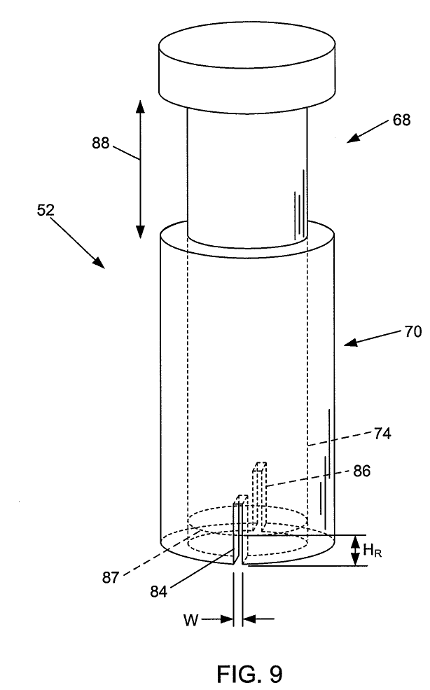

Referring now to FIGS. 8 and 9, the operation of the first and second variable orifices 66, 67 will be described. The flow size of each of the first and second variable orifices 66, 67 through which fluid can flow is dependent on the interaction between the end 87 of the rod 68 and each of the first and second openings 84, 86 in the second axial end portion 78 of the sleeve 70. As previously stated, the rod 68 is in selective linear sliding engagement with the sleeve 70. In the subject embodiment, the rod moves in a direction perpendicular to the flow of fluid through the first and second variable orifices 66, 67. As the rod 68 selectively moves in a linear direction 88 relative to the sleeve 70, the flow size of each of the first and second variable orifices 66, 67 varies.

In FIG. 8, the rod 68 is shown in a fully extended position relative to the sleeve 70. In this fully extended position, the end 87 of the second portion 74 of the rod 68 does not block the first and second openings 84, 86 in the sleeve 70. Therefore, fluid flows unrestricted through each of the first and second variable orifices 66, 67. With the rod 68 in the fully extended position, the flow size of each of the first and second variable orifices 66, 67 would be based on the width W and height H of the first and second openings 84, 86.

In FIG. 9, the rod 68 is in a partially retracted position relative to the sleeve 70. In this partially retracted position, the end 87 of the second portion 74 of the rod 68 partially blocks each of the first and second openings 84, 86 in the sleeve 70. Therefore, fluid flow through the first and second variable orifices 66, 67 is restricted. With the rod 68 in the partially retracted position, the flow size of each of the first and second variable orifices 66, 67 would be based on the width W of the first and second openings 84, 86 and a height H_{R} of the rod 68 with respect to the second axial end portion 78 of the sleeve 70.

Referring now to FIGS. 4 and 6, the second portion 74 of the rod 68 of the orifice assembly 52 is inserted through the first end 60 of the central opening 56 of the actuator collar 50 and through the second end 62 until the shoulder 75 of the first portion 72 of the rod 68 abuts the step 65 of the actuator collar 50. In the subject embodiment, the outer diameter D1 of the first portion 72 of the rod 68 is sized to provide adequate engagement between the shoulder 75 and the step 65. With the shoulder 75 of the first portion 72 of the rod 68 abutting the step 65 of the actuator collar 50, a plug 89 is engaged with the first end 60 of the actuator collar 50. In the subject embodiment, the plug 89 is in threaded engagement with the internally threaded portion 64 of the central opening 56 of the actuator collar 50.

A compressible member 90 is disposed in the central opening 56 between the plug 89 and the rod 68 such that the compressible member 90 is disposed between an end surface 92 of the rod 68 and a surface 94 of the plug 89. The compressible member 90 allows the rod 68 to be aligned in the bore 80 of the sleeve 70 even during slight misalignment of the central axis 58 of the actuator collar 50 and the center axis 82 of the sleeve 70.

The actuator collar 50 is adapted for sliding linear movement relative to the housing 12. In the subject embodiment, the actuator collar 50 is disposed in an actuator bore 96 disposed in a position sensing assembly, generally designated 98, which is disposed in the actuator cavity 46 of the housing 12. The position sensing assembly 98 includes a body 100 and at least one position sensor 102, which will be described subsequently. The body 100 defines a recess 104 that is adapted to receive a protrusion 106 (best shown in FIG. 2) in the actuator cavity 46. The recess 104 and the protrusion 106 provide keyed engagement between the position sensing assembly 98 and the housing 12 so as to prevent any rotational movement of the position sensing assembly 98 relative to the housing 12.

The body 100 further defines the actuator bore 96 and a rod opening 108. The rod opening 108 extends from the actuator bore 96 through the body 100 of the position sensing assembly 98 such that the rod opening 108 is coaxial with the actuator bore 96. It will be understood, however, that the scope of the present disclosure is not limited to the rod opening 108 being coaxial with the actuator bore 96. The rod opening 108 of the body 100 has a diameter that is smaller than the diameter of the actuator bore 96. The difference in diameters of the rod opening 108 and the actuator bore 96 forms a base 110 disposed between the actuator bore 96 and the rod opening 108.

With the sleeve 70 disposed in the housing 12, the position sensing assembly 98 is oriented within the actuator cavity 46 of the housing 12 such that the recess 104 and the protrusion 106 are engaged and the rod opening 108 is generally aligned with the bore 80 of the sleeve 70. The actuator assembly 48 is then inserted into the actuator bore 96 of the position sensing assembly 98 such that the second portion 74 of the rod 68 passes through the rod opening 108 of the position sensing assembly 98 and into the bore 80 in the sleeve 70.

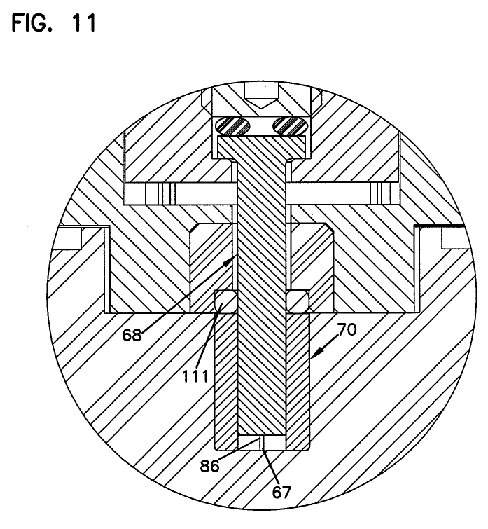

A sealing member 111 (shown in FIG. 11) is disposed between the sleeve 70 and the position sensing assembly 98. The sealing member 111 prevents fluid leakage resulting from the clearance between the rod 68 and the bore 80 of the sleeve 70 from flowing through the rod opening 108 of the position sensing assembly 98.

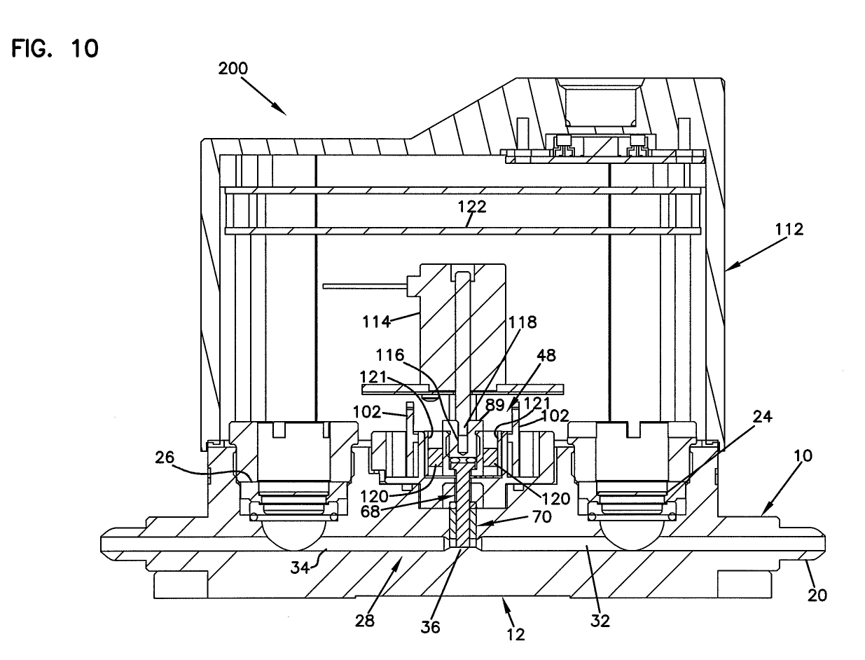

Referring now to FIG. 10, a flow device assembly 200 is shown. The flow device assembly 200 includes the flow device 10 and an electronic controller, generally designated 112. The electronic controller 112 includes a linear actuator 114 such as a stepper motor, a hydraulic or pneumatic actuator, a solenoid, a servo motor, or a manual device such as a threaded shaft with a thumb turn button. The linear actuator 114 selectively moves in the linear direction 88 (shown as an arrow in FIGS. 8 and 9). The actuator assembly 48 of the flow device 10 is coupled to the linear actuator 114 such that the movement of the linear actuator provides movement of the rod 68 in the linear direction 88 relative to the sleeve 70. In the subject embodiment, the coupling of the actuator assembly 48 to the linear actuator 114 is provided through an opening 116 in the plug 89 of the actuator assembly 48, which is adapted to receive an end 118 of the linear actuator 114. The engagement between the end 118 of the linear actuator 114 and the opening 116 of the plug 89 can be secured, for example, by a press fit, a threaded fit, a bonded fit, a soldered fit, a detent, etc.

The position sensor 102 in the position sensing assembly 98 measures the movement of the rod 68 relative to the sleeve 70. In the subject embodiment, the position sensor 102 is a Hall Effect sensor. It will be understood, however, that the scope of the present disclosure is not limited to the position sensor 102 being a Hall Effect sensor as other linear measurement devices such as LVDTs could also be used. Hall Effect sensors can be used to measure position by measuring the changes in a magnetic field. In the subject embodiment, a magnet 120 is disposed in at least one magnet opening 121 disposed in the actuator collar 50 to create a magnetic field that the Hall Effect sensor can measure. As Hall Effect sensors are sensitive to movement of magnetic fields in all directions, multiple Hall Effect sensors can be used to provide data regarding movement in a particular direction by reducing or canceling the effect of movement of the magnetic field in undesired directions. In the subject embodiment, there are two position sensors 102 and two magnets 120, with one magnet 120 in each of two magnet openings 121, positioned around the actuator assembly 48 in 180 degree increments. These two position sensors 102 provide data regarding movement of the magnetic field, which is correlated to movement of the rod 68 relative to the sleeve 70, in the linear direction 88 by reducing or canceling the effects of movement in other directions. In another embodiment, at least one position sensor 102 and one magnet 120 in one magnet opening 121 are used to measure the movement of the rod 68 relative to the sleeve 70. In yet another embodiment, four position sensors 102 and four magnets 120, with one magnet 120 in each of four magnet openings 121 are used to measure the movement of the rod 68 relative to the sleeve 70.

Referring now to FIGS. 10 and 11, the operation of the flow device 10 will be described. Fluid enters the flow device 10 through the inlet connector 20 of the housing 12 and passes through the inlet portion 32 of the conduit 28 where the inlet pressure sensor 24 measures the pressure of the incoming fluid. The pressure information from the inlet pressure sensor 24 is sent to a microcontroller 122.

If the first and second variable orifices 66, 67 of the orifice assembly 52 are open, an amount of fluid flows through the orifice portion 36 of the conduit 28 into the outlet portion 34. The amount of fluid that passes through the orifice portion 36 of the conduit 28 depends on the pressure of the incoming fluid, the density and viscosity of the fluid, and the size of each of the first and second variable orifices 66, 67. The outlet pressure sensor 26 measures the pressure of the fluid in the outlet portion 34 of the conduit 28 and provides this information to the microcontroller 122. The fluid then flows through the outlet connector 22.

Using information supplied by the inlet and outlet pressure sensors 24, 26 and the position sensors 102, the microcontroller precisely controls the flow of fluid through the first and second variable orifices 66, 67. The flow rate through the first and second variable orifices 66, 67 is characterized by the following equation:

$$Q = \frac{K * π * {d}^{1 / 2}}{4} * {( 2 * \frac{{P}_{HI} - {P}_{LO}}{ρ} )}^{1 / 2} ,$$

where Q is the volumetric flow rate, K is the orifice flow coefficient, d is the hydraulic diameter of the orifice, P_{HI} is the pressure of the fluid in the inlet portion 32 of the conduit 28 as measured by the inlet pressure sensor 24, P_{LO} is the pressure of the fluid in the outlet portion 34 of the conduit 28 as measured by the outlet pressure sensor 26, and ρ is the density of the fluid.

During operation of the flow device 10 in the subject embodiment, the hydraulic diameter, d, of the first and second variable orifices 66, 67 is computed by the microcontroller 122 in the electronic controller 112 based on the width W of the first and second openings 84, 86 and the linear position of the rod 68 relative to the sleeve 70. The width W of the first and second openings 84, 86 can be measured at the time of manufacturing while the linear position of the rod 68 relative to the sleeve 70 can be measured by the position sensor 102. Based on this computed value and the fluid pressure of the incoming and outgoing fluid, the flow rate Q can be precisely controlled. For example, if the computed flow rate Q is either higher or lower than a desired value, the microcontroller 122 can adjust the linear position of the rod 68 relative to the sleeve 70 by actuating the linear actuator 114. If the linear position of the rod 68 relative to the sleeve 70 is adjusted such that the size of the first and second variable orifices 66, 67 is reduced, the flow rate Q will decrease. If the linear position of the rod 68 relative to the sleeve 70 is adjusted such that the size of the first and second variable orifices 66, 67 is increased, the flow rate Q will increase. The implementation of this equation in a flow controller is described in U.S. Pat. Nos. 7,096,744 and 7,082,842, which are hereby incorporated by reference.

If the first and second openings 84, 86 have shapes and dimensions that are substantially similar, the first and second variable orifices 66, 67 act as a single orifice. In this embodiment, the microcontroller 122 could compute the hydraulic diameter, d, for either one of the first and second variable orifices 66, 67. If, however, the first and second openings 84, 86 have different shapes and dimensions, the first and second variable orifices 66, 67 act as two orifices in series. In one embodiment in which the first and second orifices 66, 67 are different shapes, the microcontroller 122 computes the hydraulic diameter, d, for each of the first and second orifices 66, 67. In another embodiment in which the first and second orifices 66, 67 are different shapes, the microcontroller 122 computes the hydraulic diameter, d, for the smallest orifice of the first and second orifices 66, 67 since the smallest orifice of the first and second orifices 66, 67 will be the most restrictive to fluid flow.

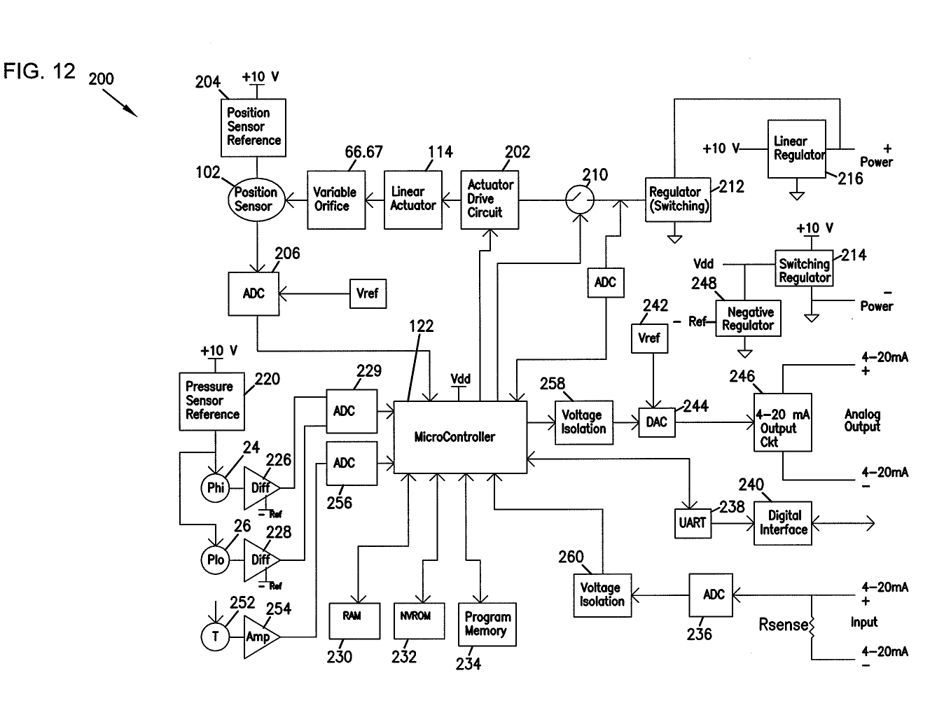

Referring now to FIG. 12, the components of an embodiment of the flow device 10 are shown schematically as part of a flow device assembly 200. The flow device assembly 200 includes the microcontroller 122 that controls and communicates with most of the other flow device assembly 200 components. The flow device assembly 200 includes components such as an actuator drive circuit 202, the linear actuator 114, a position sensor reference 204, the position sensor 102, and an analog-to-digital converter (ADC) 206 that relate to the first and second variable orifices 66, 67. The flow device assembly 200 further includes components such as a switch 210, a regulator 212, a switching regulator 214, and a linear regulator 216 that control power to the linear actuator 114, the position sensor reference 204, the position sensor 102, and the ADC 206. The microcontroller 122 can be any suitable processor or controller such as, for example, the HD64F3062 microprocessor manufactured by RENESAS of San Jose, Calif.

The flow device assembly 200 also includes a pressure sensor reference 220, the inlet pressure sensor 24, the outlet pressure sensor 26, and difference amplifiers 226, 228 and an ADC 229 that together are used to determine a pressure differential in the flow device 10.

Different memory devices such as RAM 230, NVROM 232, and program memory 234 can be used by the microcontroller 122 to store data, such as that use in the equation discussed above, instructions, code, algorithms, etc.

The microcontroller 122 can receive inputs in the form of current signals having a magnitude of, for example, 4-20 mA that are converted to digital signals using ADC 236, and can communicate with direct digital signals through a UART 238 and a digital interface 240. The microcontroller 122 can also generate output signals that are converted to analog signals with a voltage reference 242, digital-to-analog converter (DAC) 244 and an output circuit 246 that generates signals having a magnitude of, for example, 4-20 mA. The flow device assembly 200 can use a power source that includes a negative regulator 248 and the switching regulator 214 for powering various components of the flow device assembly 200.

Temperature input 252 is provided to the microcontroller 122 via an amplifier 254 and an ADC 256. Voltage isolation blocks 258 and 260 can be provided to isolate the microcontroller 122 from input and output devices.

In response to pressure signals from the inlet pressure sensor 24 and the outlet pressure sensor 26, the microcontroller 122 can change the size of the first and second variable orifices 66, 67 by altering the physical position of the rod 68 relative to the sleeve 70. To do so, the microcontroller 122 utilizes the actuator drive circuit block 202 to engage the linear actuator 114. This in-turn moves the actuator assembly 48 in the linear direction 88, which moves the rod 68 relative to the sleeve 70. The position sensor 102 can provide feedback on the actual or implied height H_{R} of the rod 68 relative to the sleeve 70.

The microcontroller 122 computes the volumetric flow rate, Q, by computing the size of each of the first and second variable orifices 66, 67, as described above, and by measuring the pressure drop across the first and second variable orifices 66, 67. The first and second variable orifices 66, 67 serve as the restriction for a differential pressure based flow meter, and can also serve as the valve to control the flow rate. Therefore, to perform flow control, a valve separate from the flow device 10 is not required. Therefore, the components shown in FIGS. 1-10, combined with microprocessor based electronics of FIG. 12 form a complete flow meter/controller.

Because the first and second variable orifices 66, 67 perform the valve function when used for flow control, the inlet and outlet fluid pressures of the first and second variable orifices 66, 67 are monitored. The position sensor 102 monitors the position of the rod 68, which slides back and forth in the bore 80 of the sleeve 70 to vary the size of the first and second variable orifices 66, 67. Also shown in FIG. 12 is a temperature sensor 252 that preferably physically resides in the upstream pressure sensor. The temperature sensor 252 is used to monitor the temperature of the fluid flowing through the flow meter/controller. As the temperature of the fluid affects the fluid density ρ, which is used to calculate the volumetric flow rate Q, the temperature sensor 252 provides information that can be used in calculating an accurate value for the volumetric flow rate Q. In addition, it may be advantageous to know the temperature of the fluid in order to control the fluid temperature during use of the flow device 10. In the subject embodiment, this temperature sensor 252 is mounted in close proximity to the diaphragm of the pressure sensor.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. An orifice assembly, comprising:
a sleeve having a first axial end portion, a second axial end portion, an outer surface, and a bore that extends through the first and second axial ends, the second axial end portion defines at least a first opening, wherein the first opening extends from the outer surface into the bore; and
a rod having a first portion and a second portion, the rod being adapted for linear sliding movement in the bore of the sleeve, wherein the second portion includes an end that cooperates with the sleeve to define a first variable orifice and a second variable orifice.

2. An orifice assembly as claimed in claim 1, wherein the rod is generally cylindrical and the first portion of the rod has a larger diameter than the second portion of the rod.

3. An orifice assembly as claimed in claim 1, wherein the second axial end portion defines a second opening.

4. An orifice assembly as claimed in claim 3, wherein the rod cooperates with the first opening and the second opening to define the first variable orifice and the second variable orifice.

5. An orifice assembly as claimed in claim 3, wherein the first opening and the second opening are the same shape.

6. An orifice assembly as claimed in claim 5, wherein the first opening and the second opening are rectangular in shape.

7. An orifice assembly as claimed in claim 6, wherein a width of each of the first opening and the second opening is in the range of about 0.005 to about 0.02 inches.

8. An orifice assembly as claimed in claim 3, wherein the first opening and the second opening are different shapes.

9. An orifice assembly as claimed in claim 3, wherein the first and second openings are disposed about the sleeve so as to be spaced apart in the range of about 160 to 200 degrees.

10. An orifice assembly as claimed in claim 1, wherein the rod and sleeve each comprise a material having properties of corrosion resistance and wear resistance.

11. An orifice assembly as claimed in claim 10, wherein the material is a single crystal sapphire material.

12. A flow device for controlling fluid flow, comprising:
a housing defining a conduit having an inlet portion, an outlet portion, and an orifice portion disposed between the inlet portion and the outlet portion;
a pressure sensor disposed in the housing for measuring the pressure of fluid in the conduit; and
an orifice assembly disposed in the orifice portion of the conduit, the orifice assembly including a rod and a sleeve, the rod being slidably moveable within a bore of the sleeve, the sleeve defining a first opening and a second opening, wherein the rod cooperates with the first opening and the second opening to define an orifice.

13. A flow device for controlling fluid flow as claimed in claim 12, wherein the orifice includes a first variable orifice and a second variable orifice arranged in series that operate as a single orifice.

14. A flow device for controlling fluid flow as claimed in claim 12, wherein the conduit is disposed along a longitudinal axis.

15. A flow device for controlling fluid flow as claimed in claim 12, wherein the rod has a generally cylindrical cross-sectional shape.

16. A flow device for controlling fluid flow as claimed in claim 14, wherein the rod is movable in a direction perpendicular to the longitudinal axis.

17. A flow device for controlling fluid flow as claimed in claim 12, further comprising at least one position sensor disposed in the housing for measuring the linear movement of the rod relative to the sleeve.

18. A flow device for controlling fluid flow as claimed in claim 17, wherein the position sensor is a Hall-effect sensor.

19. A flow device for controlling fluid flow as claimed in claim 13, wherein the first variable orifice is the same shape as the second variable orifice.

20. A flow device for controlling fluid flow as claimed in claim 13, wherein the first and second variable orifices change size simultaneously with sliding movement of the rod in the bore of the sleeve.

21. A method for controlling a flow device assembly, the flow device assembly having a housing, a conduit, a rod, a sleeve, and a pressure sensor, the sleeve including first and second openings, the method comprising the steps of:
measuring the pressure of fluid in the conduit of the housing with the pressure sensor, the pressure sensor being disposed in the housing;
measuring a position of the rod in the sleeve, the rod and the sleeve being disposed in an orifice portion of the conduit, wherein an end of the rod cooperates with the first and second openings in the sleeve to define a first variable orifice and a second variable orifice;
computing the flow rate of fluid through at least one of the first variable orifice and the second variable orifice; and
adjusting the size of at least one of the first variable orifice and the second variable orifice by moving the rod relative to the sleeve.

22. A method for controlling a flow device assembly as claimed in claim 20, wherein the adjusting step includes adjusting the size of the first and second variable orifices simultaneously.

23. A method for controlling a flow device assembly as claimed in claim 20, wherein the adjusting step includes maintaining the first and second variable orifices with substantially the same shape and size.

24. A method for controlling a flow device assembly as claimed in claim 20, wherein the adjusting step includes changing a shape of at least one of the first and second variable orifices from a first rectangular shape to a second rectangular shape, wherein the first and second rectangular shapes have difference cross-sectional areas.
